(19) United States
(12) Patent Application Publication
(10) Pub. No.: US 2004/0115491 A1
(43) Pub. Date: Jun. 17, 2004

(54) System and method for process gas stream delivery and regulation using open loop and closed loop control

(75) Inventors: Joseph Cargnelli, Toronto (CA); Todd A. Simpson, Brampton (CA); Stephen Burany, Thornhill (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation, Mississauga (CA)

(21) Appl. No.: 10/667,900

(22) Filed: Sep. 23, 2003

Related U.S. Application Data
(60) Provisional application No. 60/412,587, filed on Sep. 23, 2002.
(60) Provisional application No. 60/412,548, filed on Sep. 23, 2002.

(51) Int. Cl. H01M 8/04

(52) U.S. Cl. 429/13; 429/23; 429/22; 700/286

(57) ABSTRACT

A method and apparatus are provided for delivery and regulation of process fluid flow of a multi-cell electrochemical device. A controller regulates the process fluid flow using pre-determined setpoints stored in the controller until at least one of the process parameters has reached a pre-determined value when the controller is switched to the open loop control mode, and the controller regulates the process fluid flow using at least one of the process parameter signals when the controller is switched to the closed loop control mode.

### FIELD OF THE INVENTION

The present invention relates to a system and method for delivering and regulating process gas streams to fuel cell stacks.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode. Simultaneously, an oxidant, such as oxygen or air is introduced to the second electrode where the oxidant reacts electrochemically in presence of the electrolyte and catalyst, producing anions and consuming the electrons circulated through the electrical circuit; the cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the two electrodes are, respectively, as follows:

H2→2H++2e−

½O₂+2H++2e−→H₂O

The external electrical circuit withdraws electrical current and thus receives electrical power from the cell. The overall fuel cell reaction produces electrical energy as shown by the sum of the separate half-cell reactions written above. Water and heat are typical by-products of the reaction.

In practice, fuel cells are not operated as single units. Rather, fuel cells are connected in series, stacked one on top of the other, or placed side by side. A series of fuel cells, referred to as a fuel cell stack, is normally enclosed in a housing. The fuel and oxidant are directed through manifolds to the electrodes, while cooling is provided either by the reactants or by a cooling medium. Also within the stack are current collectors, cell-to-cell seals and insulation, with required piping and instrumentation provided externally of the fuel cell stack. The stack, housing, and associated hardware make up the fuel cell module.

The optimal operating level of components of the fuel cell system will depend upon the particular system operating level of the entire fuel cell system. Thus, for example, the optimal operating level of a blower for providing process fluids to the fuel cell system will depend upon the particular system operating level of the fuel cell system. As the operating level of the fuel cell system increases, the optimal operating level of the blower will also increase. In prior art systems, feedback from process parameters, such as cathode airflow, various temperatures and fuel cell voltages, are monitored and are used to either increase or decrease the operating level of individual components of the fuel cell system based upon the needs of the fuel cell system.

### SUMMARY OF THE INVENTION

According to aspects of the invention, there is provided a method and system for rapidly bringing a component of a fuel cell system close to an optimal operating level using a combination of open loop and closed loop process control. This is particularly important where the load placed on the fuel cell system varies sharply and dramatically, such that closed loop process control on its own may take some time to move individual components of the fuel cell system to their new optimal operating levels, thereby reducing the efficiency of the fuel cell system.

In accordance with an aspect of the invention, there is provided a method of controlling a component of a fuel cell system, the method comprising: (a) determining a current operating level of the fuel cell system; (b) based on the current operating level of the fuel cell system, determining a corresponding setpoint operating level of the component in the fuel cell system; (c) adjusting the component toward operating at the corresponding setpoint operating level for the current operating level of the fuel cell system; and, (d) controlling the operating level of the component based on closed loop feedback when the operating level of the component is within a selected difference from the corresponding setpoint operating level.

In accordance with second aspect of the invention, there is provided a system for controlling at least one component of a fuel cell system. The system comprises (a) a plurality of measuring devices for measuring an operating level of the fuel cell system and an operating level of the at least one component; (b) a storage module for storing an associated setpoint operating level of at least one component in the fuel cell system for each operating level in a plurality of operating levels of the fuel cell system; and (c) a controller for adjusting the at least one component of the fuel cell system. The controller is operable during an open loop control phase to adjust the at least one component toward operating at the associated setpoint operating level for the current operating level of the fuel cell system. The controller is operable during a closed loop control phase to adjust the operating level of the at least one component based on information from the at least one measuring device. The controller is operable to switch from the open loop control phase to the closed loop control phase when the at least one component is operating within a selected difference from the associated setpoint operating level for the current operating level of the fuel cell system.

### BRIEF DESCRIPTION OF THE DRAWINGS

For a better understanding of the present invention and to show more clearly how it may be carried into effect, reference will now be made, by way of example, to the accompanying drawings which show a preferred embodiment of the present invention and in which:

FIG. 1 is a schematic flow diagram of a first embodiment of a fuel cell gas and water management system in accordance with an aspect of the present invention; and,

FIG. 2 is a block diagram of a controller for use in connection with the fuel cell gas and water management system of FIG. 1 in accordance with a preferred embodiment of the invention.

### DETAILED DESCRIPTION OF THE INVENTION

For delivering and regulating process fluids, for example air and hydrogen gas streams, to a fuel cell stack, it is important to provide the process fluids in a required amount at a precise time. The following description will use as an example the delivery and regulation of air to a cathode portion of a fuel cell stack 12. The same general principles can also be applied to other fluid deliveries, for example the hydrogen gas stream to the fuel cell stack.

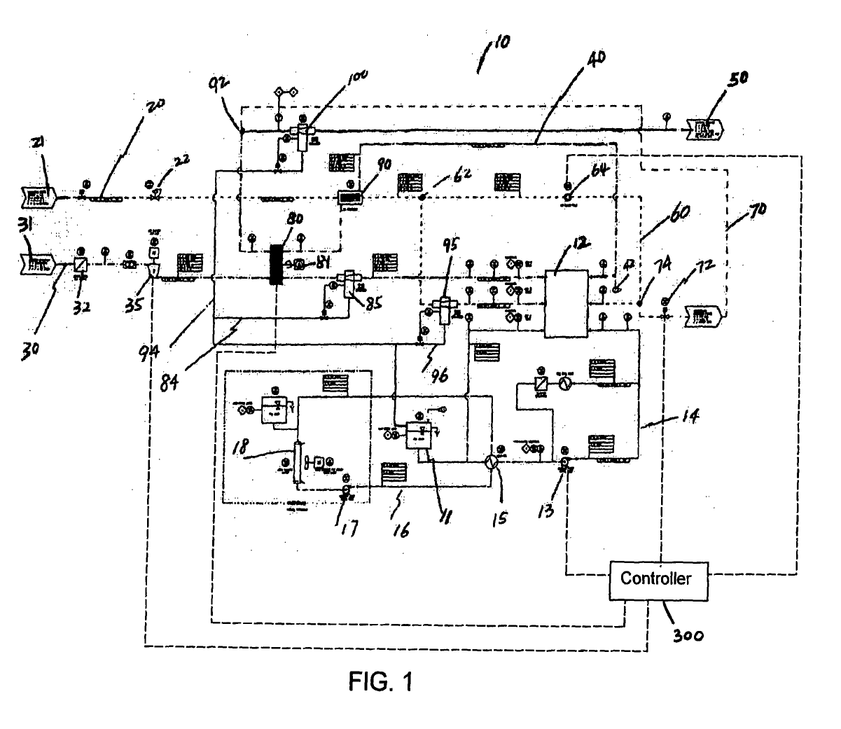

Referring to FIG. 1, this shows a schematic flow diagram of a fuel cell gas management system 10 in accordance with an aspect of the present invention. The fuel cell gas management system comprises a fuel supply line 20, an oxidant supply line 30, a cathode exhaust recirculation line 40 and an anode exhaust recirculation line 60, all connected to the fuel cell 12. It is to be understood that the fuel cell may comprise a plurality of fuel cells (stack) or just a single fuel cell. For simplicity, the fuel cell 12 described herein operates on hydrogen as fuel and air as oxidant and can be a Proton Exchange Membrane (PEM) fuel cell. However, the present invention is not limited to this type of fuel cells and is applicable to other types of fuel cells.

The fuel supply line 20 is connected to a fuel source 21 for supplying hydrogen to the anode of the fuel cell 12. A hydrogen humidifier 90 is disposed in the fuel supply line 20 upstream from the fuel cell 12 and an anode water separator 95 is disposed between the hydrogen humidifier 90 and the fuel cell 12. The oxidant supply line 30 is connected to an oxidant source 31. e.g. ambient air, for supplying air to the cathode of the fuel cell 12. An enthalpy wheel 80 is disposed in the oxidant supply line 30 upstream of the fuel cell 12 and also in the cathode recirculation line 40. A cathode water separator 85 is disposed between the enthalpy wheel 80 and the fuel cell 12. The enthalpy wheel 80 comprises porous materials with a desiccant. In known manner, a motor 81 drives either the porous materials or a gas diverting element to rotate around the axis of the enthalpy wheel so that gases from the oxidant supply line 30 and the oxidant recirculation line 40 alternately pass through the porous materials of the enthalpy wheel. Dry ambient air enters the oxidant supply line 30 and first passes through an air filter 32 that filters out the impurity particles. A blower 35 is disposed upstream of the enthalpy wheel 80, to draw air from the air filter 32 and to pass the air through a first region of the enthalpy wheel 80. The enthalpy wheel 80 may be any commercially available enthalpy wheel suitable for fuel cell system, such as the one described in the applicant's co-pending U.S. patent application Ser. No. 09/941,934.

A fuel cell cathode exhaust stream contains excess air, product water and water transported from the anode side, the air being nitrogen rich due to consumption of at least part of the oxygen in the fuel cell 12. The cathode exhaust stream is recirculated through the cathode exhaust recirculation line 40 connected to the cathode outlet of the fuel cell 12. The humid cathode exhaust stream first passes through the hydrogen humidifier 90 in which the heat and humidity is transferred to incoming dry hydrogen in the fuel supply line 20. The humidifier 90 can be any suitable humidifier, such as that commercially available from Perma Pure Inc, Toms River, N.J. It may also be a membrane humidifier and other types of humidifier with either high or low saturation efficiency. In view of the gases in the anode and cathode streams, an enthalpy wheel or other device permitting significant heat and humidity interchange between the two streams cannot be used.

From the hydrogen humidifier 90, the fuel cell cathode exhaust stream continues to flow along the recirculation line 40 and passes through a second region of the enthalpy wheel 80, as mentioned above. As the humid cathode exhaust passes through the second region of the enthalpy wheel 80, the heat and moisture is retained in the porous paper or fiber material of the enthalpy wheel 80 and transferred to the incoming dry air stream passing through the first region of the enthalpy wheel 80 in the oxidant supply line 30, as the porous materials or the gas diverting element of the enthalpy wheel 80 rotate around its axis. Then the cathode exhaust stream continues to flow along the recirculation line 40 to an exhaust oxidant water separator 100 in which the excess water, again in liquid form, that has not been transferred to the incoming hydrogen and air streams is separated from the exhaust stream. Then the exhaust stream is discharged to the environment along a discharge line 50.

A drain line 42 may optionally be provided in the recirculation line 40 adjacent the cathode outlet of the fuel cell to drain out any liquid water remaining or condensed out. The drain line 42 may be suitably sized so that gas bubbles in the drain line actually retain the water in the drain line and automatically drain water on a substantially regular basis, thereby avoiding the need of a drain valve that is commonly used in the field to drain water out of gas stream. Such a drain line can be used anywhere in the system where liquid water needs to be drained out from gas streams. Pressure typically increases with gas flow rate and water regularly produced or condensed, and a small flow rate of gas is not detrimental such as cathode exhaust water knockout separator and drain line 42.

The humidified hydrogen from the hydrogen humidifier 90 flows along the fuel supply line 20 to the anode water separator 95 in which excess water is separated before the hydrogen enters the fuel cell 12. Likewise, the humidified air from the enthalpy wheel 80 flows along the oxidant supply line 30 to the cathode water separator 85 in which excess liquid water is separated before the air enters the fuel cell 12.

Fuel cell anode exhaust comprising excess hydrogen and water is recirculated by a pump 64 along an anode recirculation line 60 connected to the anode outlet of the fuel cell 12. The anode recirculation line 60 connects to the fuel supply line 20 at a joint 62 upstream from the anode water separator 95. The recirculation of the excess hydrogen together with water vapor not only permits utilization of hydrogen to the greatest possible extent and prevents liquid water from blocking hydrogen reactant delivery to the reactant sites, but also achieves self-humidification of the fuel stream since the water vapor from the recirculated hydrogen humidifies the incoming hydrogen from the hydrogen humidifier 90. This is highly desirable since this arrangement offers more flexibility in the choice of hydrogen humidifier 90 as the humidifier 90 does not then need to be a highly efficient one in the present system. By appropriately selecting the hydrogen recirculation flow rate, the required efficiency of the hydrogen humidifier 90 can be minimized. For example, supposing the fuel cell 12 needs 1 unit of hydrogen, hydrogen can be supplied from the hydrogen source in the amount of 3 units with 2 units of excess hydrogen recirculated together with water vapor. The speed of pump 64 may be varied to adjust the portion of recirculated hydrogen in the mixture of hydrogen downstream from joint 62. The selection of stoichiometry and pump 64 speed may eventually lead to the omission of the hydrogen humidifier 90.

In practice, since air is used as oxidant, it has been found that nitrogen crossover from the cathode side of the fuel cell to the anode side can occur, e.g. through the membrane of a PEM fuel cell. Therefore, the anode exhaust may actually contain some nitrogen and possibly other impurities. Recirculation of anode exhaust may result in the build-up of nitrogen and poison the full cell. Preferably, a hydrogen purge line 70 branches out from the fuel recirculation line 60 from a position 74 adjacent the fuel cell cathode outlet. A purge control device 72 is disposed in the hydrogen purge line 70 to purge a portion of the anode exhaust out of the recirculation line 60. The frequency and flow rate of the purge operation depends on the power at which the fuel cell 12 is running. When the fuel cell 12 is running at high power, it is desirable to purge a higher portion of anode exhaust. The purge control device 72 may be a solenoid valve or other suitable device.

The hydrogen purge line 70 runs from the position 74 to a joint point 92 at which it joins the cathode exhaust recirculation line 40. Then the mixture of purged hydrogen and the cathode exhaust from the enthalpy wheel 80 passes through the exhaust water separator 100. Water is condensed in the water separator 100 and the remaining gas mixture is discharged to the environment along the discharge line 50. Alternatively, either the cathode exhaust recirculation line 40 or the purge line 70 can be connected directly into the water separator 100.

Preferably, water separated by the anode water separator 95, cathode water separator 85, and the exhaust water separator 100 are not discharged, but rather the water is recovered respectively along line 96, line 84 and line 94 to a product water tank (not shown), for use in various processes.

As is known to those skilled in the art, a coolant loop 14 runs through the fuel cell 12. A pump 13 is disposed in the cooling loop 14 for circulating the coolant. The coolant may be any coolant commonly used in the field, such as any non-conductive water, glycol, etc. An expansion tank 11 can be provided in known manner. A heat exchanger 15 is provided in the cooling loop 14 for cooling the coolant flowing through the fuel cell 12 to maintain the coolant within an appropriate temperature range. FIG. 1 shows one variant, in which a secondary loop 16 includes a pump 17, to circulate a secondary coolant. A heat exchanger 18, e.g. a radiator, is provided to maintain the temperature of the coolant in the secondary loop and again, where required, an expansion tank 19 is provided. The coolant in the cooling loop 16 may be any type of coolant as the coolants in cooling loop 14 and 16 do not mix.

According to an aspect of the present invention, a combination of open loop and closed loop process control is used to efficiently and securely regulate th cathode air delivery by controlling the blower 35 rotation speed. Generally, a component of the fuel cell system 10 is examined and its behavior in the system is determined (under working conditions) to chart how the component performs under various operating conditions. As will be explained in more detail below, how the component has performed in the past under various operating condition will provide information regarding the optimal operating levels of the device under these operating conditions. The gathered information is captured and used in by a controller 300 to allow a stable and fast response during open loop regulation by specifying the approximate setpoints at which a specific device should operate when the fuel cell system is at a particular system operating point. Thus, for example, the air blower is regulated, under open loop conditions, by being brought to the operating levels the air blower was taken to under closed loop process control during previous operations when the fuel cell system was operating at the same or close to the same system operating point.

According to other aspects of the present invention, a combination of open loop and closed loop process control is used to efficiently and securely regulate other components of the fuel cell system. For example the hydrogen purge rate and hydrogen coolant recirculation rate can be regulated by controlling the purge control device 72 and pump 64 respectively. Typically, these components would be controlled based on the fuel cell system voltage and current. The coolant recirculation rate can be regulated by controlling the purge control pump 13, typically based on the inlet and outlet temperatures of the fuel cell stack and its generated electrical current. The speed of the enthalpy wheel 80 can be controlled based on the cathode inlet temperature and the fuel cell stack current.

As described above, the optimal operating levels of these components is determined as a function of the fuel cell operating level as determined by different measurements. Generally, this can be done theoretically, using a model of the fuel cell system 10, or empirically by observing the operating conditions of the fuel cell system 10. As the operating conditions of the fuel cell system 10 are, according to the present invention, controlled by a closed loop process control, each component so controlled will gradually approach it's optimal operating level given a particular operating level of the fuel cell system as a whole. This optimal operating level can then be recorded as the approximate setpoint at which a specific device should operate when the fuel cell system is at a particular system operating point. In general, empirical control is preferred over theoretical control, as empirical control will automatically track changes in the optimal operating levels of the various components of the fuel cell system due, for example, to aging and/or damage.

This quickly brings the different components of the fuel cell system to operating points near the desired operating points, without any need for feedback control. Various process parameters, such as cathode airflow and various temperatures and fuel cell voltages, are monitored during the open loop regulation phase to determine when the pre-defined desired operating points have been reached. At this point, once the system has been determined to be “close enough” to the desired operating point, system regulation is switched over to a closed loop regulation control. Thereafter, feedback from the monitored process parameters is used to govern the direction of the actual regulation of the system. Once in closed loop control, the control scheme will bring each controlled device very close to its optimal operating point based on previous fuel cell system operation. This information will then be stored, and used during subsequent operations to determine the setpoints for operating levels for individual fuel cell components that are optimal for particular system operating levels for the fuel cell system as a whole, These setpoints will be used in future open loop process control.

The benefit of using a combination of open loop and closed loop control schemes in series is that the fuel cell system first is brought very quickly and stably to near the desired operating condition at which point the closed loop control will bring the system accurately to the final desired operating point, taking into account variables which were not present or not identified during the initial characterizing phase for the device or devices in question. The closed loop control will thus compensate for system variance as the system ages and as the operating conditions vary (for example if a channel flooding occurs in a fuel cell flow plate).

As an example, the switchover from open loop to closed loop control can be set to occur within a certain percentage of the actual setpoint, possibly 10% in the example with cathode air flow. The percentage varies depending upon what device is being controlled, among other things because of different device stability during operation.

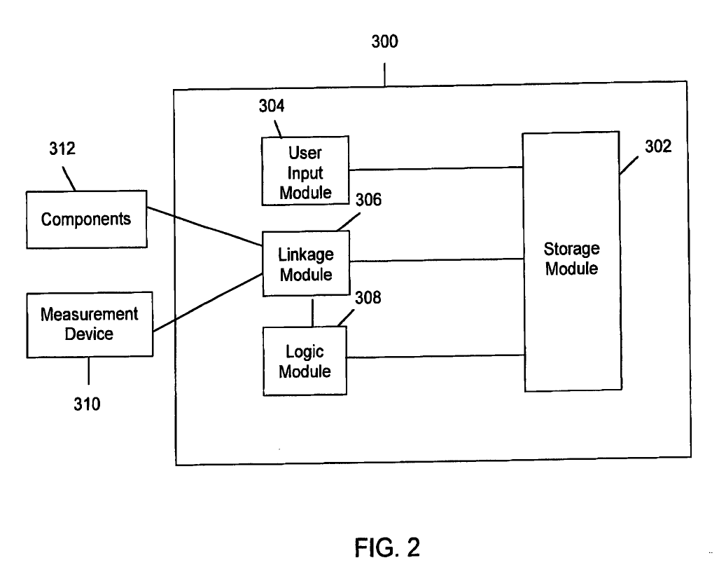

Referring to FIG. 2, there is illustrated in a block diagram the controller 300 in accordance with an embodiment of the invention. The controller includes a storage module 302, a user input module 304, a linkage module 306 and a logic module 308 as shown. The storage module 302 is operable to store setpoint operating levels as described above. As described above, these setpoint operating levels are, preferably, recorded from previous operations of the fuel cell system. To this end, the storage module 302 is linked to a linkage module 306, which, in turn, is linked to measurement devices 310 distributed throughout the fuel cell system. Through these measurement devices, the linkage module 306 monitors various parameters of the fuel cell system, such as, for example, cell voltages, stack currents or various temperatures, to determine the operating level of both the fuel cell system and individual components 312 of the fuel cell system. When an operating level of a particular component of the fuel cell system remains reasonably constant under closed loop feedback control for a particular operating level of the fuel cell system as a whole, the logic module 308, which is also linked to the linkage module 306, will determine that this actual operating level represents an optimal or setpoint operating level of a particular component in the fuel cell system for the overall operating level of the fuel cell system. At that point, the linkage module 306 will communicate both the overall operating level of the fuel cell system and the actual operating level of the particular component to the storage module 302, in which the operating level of the component will be stored as the setpoint operating level of that component for the overall operating level of the fuel cell system.

Alternatively, the corresponding setpoint operating levels of components for particular operating levels of the fuel cell system as a whole can be determined theoretically by the logic module, or can be determined outside of the controller 300 and input by a user/operator via the user input module 304.

As described above, different thresholds can be set for different components at which the controller 300 switches from open loop to closed loop process control. For the blower 35, the example above specifies the selected difference of 10% from the setpoint operating level of the blower before the controller switches to closed loop process control. For other components, different percentage differences may be selected, and input through the user input module 304, from where they are communicated to the storage module 302 and stored. These selected percentage differences, will then be retrievable by the logic module 308, which module will determine when the contoller 300 switches from an open loop control phase to a closed loop control phase.

It should be further understood that various modifications can be made, by those skilled in the art, to the preferred embodiment described and illustrated herein, without departing from the present invention, the scope of which is defined in the appended claims. In particular, the present invention may be applied to advantage to control other components of the fuel cell system in addition to those described above. All such modifications are variations are believed to be within the sphere and scope of the invention as defined by the claims appended hereto.

1. A method of controlling a component of a fuel cell system, the method comprising:
a) determining a current operating level of the fuel cell system;
b) based on the current operating level of the fuel cell system, determining a corresponding setpoint operating level of the component in the fuel cell system;
c) adjusting the component toward operating at the corresponding setpoint operating level for the current operating level of the fuel cell system; and,
d) controlling the operating level of the component based on closed loop feedback when the operating level of the component is within a selected difference from the corresponding setpoint operating level.

2. The method as defined in claim 1 wherein step (b) comprises
storing a plurality of setpoint operating levels for the component in the fuel cell system, the plurality of setpoint operating levels comprising, for each operating level in a plurality of operating levels of the fuel cell system, a corresponding setpoint operating level of the component in the fuel cell system; and,
determining the corresponding setpoint operating level of the component in the fuel cell system from the plurality of setpoint operating levels.

3. The method as defined in claim 2 wherein the step of storing the plurality of setpoint operating levels for the component in the fuel cell system comprises recording, during previous operations of the fuel cell system, a plurality of actual operating levels of the component in the fuel cell system.

4. The method as defined in claim 3 wherein for each operating level in the plurality of operating levels of the fuel cell system, the corresponding setpoint operating level of the component is recorded from the actual operating level of the component when the fuel cell system is running at that operating level, the actual operating level being substantially stable under closed loop feedback.

5. The method as defined in claim 3 wherein the component controlled is one of a blower for providing process fluid flow to the fuel cell system, a coolant flow control device for providing coolant flow to the fuel cell system, a fuel flow control device for providing fuel flow to the fuel cell system, a process fluid humidification control device for controlling humidification of a process fluid and a purge control device for controlling a fuel purge rate of the fuel cell system.

6. The method as defined in claim 1 wherein
a) a plurality of components are controlled;
b) step (b) comprises based on the current operating level of the fuel cell system, determining a corresponding setpoint operating level for each component in the plurality of components;
c) adjusting each component in the plurality of components toward operating at the corresponding setpoint operating level for the current operating level of the fuel cell system; and,
d) controlling the operating level of each component in the plurality of components based on closed loop feedback when the operating level of that component is within a component-specific selected difference from the corresponding setpoint operating level.

7. The method as defined in claim 6 further comprising, for each component, selecting the component-specific selected difference from the corresponding setpoint op rating level for that component based on the operating level of the fuel cell system.

8. A system for controlling at least one component of a fuel cell system, the system comprising:
a) a plurality of measuring devices for measuring an operating level of the fuel cell system and an operating level of the at least one component;
b) a storage module for storing an associated setpoint operating level of at least one component in the fuel cell system for each operating level in a plurality of operating levels of the fuel cell system; and
c) a controller for adjusting the at least one component of the fuel cell system; wherein the controller is operable,
during an open loop control phase to adjust the at least one component toward operating at the associated setpoint operating level for the current operating level of the fuel cell system,
during a closed loop control phase to adjust the operating level of the at least one component based on information from the at least one measuring device, and
to switch from the open loop control phase to the closed loop control phase when the at least one component is operating within a selected difference from the associated setpoint operating level for the current operating level of the fuel cell system.

9. The system as defined in claim 8 further comprising a logic module for determining the associated setpoint operating level of the at least one component in the fuel cell system for each operating level in a plurality of operating levels of the fuel cell system.

10. The system as defined in claim 9 wherein the at least one component is at least one of a blower for providing process fluid flow to the fuel cell system, a coolant flow control device for providing coolant flow to the fuel cell system, a fuel flow control device for providing fuel flow to the fuel cell system, a process fluid humidification control device for controlling humidification of a process fluid and a purge control device for controlling a fuel purge rate of the fuel cell system.

11. A fuel cell system comprising:
a) a fuel cell for driving a load;
b) a plurality of measuring devices for measuring an operating level of the fuel cell system and an operating level of the at least one component;
c) a storage module for storing an associated setpoint operating level of at least one component in the fuel cell system for each operating level in a plurality of operating levels of the fuel cell system; and,
d) a controller for adjusting the at least one component of the fuel cell system; wherein the controller is operable,
during an open loop control phase to adjust the at least one component toward operating at the associated setpoint operating level for the current operating level of the fuel cell system,
during a closed loop control phase to adjust the operating level of the at least one component based on information from the at least one measuring device, and
to switch from the open loop control phase to the closed loop control phase when the at least one component is operating within a selected difference from the associated setpoint operating level for the current operating level of the fuel cell system.

12. The system as defined in claim 11 further comprising a logic module for determining the associated setpoint operating level of the at least one component in the fuel cell system for each operating level in a plurality of operating levels of the fuel cell system.

13. The system as defined in claim 12 wherein th at least one component is at least one of a blower for providing process fluid flow to the fuel cell system, a coolant flow control device for providing coolant flow to the fuel cell system, a fuel flow control device for providing fuel flow to the fuel cell system, a process fluid humidification control device for controlling humidification of a process fluid and a purge control device for controlling a fuel purge rate of the fuel cell system.
